(19) United States
(12) Patent Application Publication
(10) Pub. No.: US 2021/0068369 A1
(43) Pub. Date: Mar. 11, 2021

(54) HORSE TAIL ATTACHMENT AND PROTECTION DEVICE

(71) Applicants: Mishtu Annamarie Mukherjee, Wellesley, MA (US); Nalina Ashlee Atamian, Wellesley, MA (US); Andrea Robbins, Boston, MA (US)

(72) Inventors: Mishtu Annamarie Mukherjee, Wellesley, MA (US); Nalina Ashlee Atamian, Wellesley, MA (US); Andrea Robbins, Boston, MA (US)

(21) Appl. No.: 16/894,440

(22) Filed: Jun. 5, 2020

Related U.S. Application Data
(60) Provisional application No. 62/857,481, filed on Jun. 5, 2019.

(51) Int. Cl. A01K 13/00

(52) U.S. Cl. CPC A01K 13/005; A01K 13/003

(57) ABSTRACT

A protective sleeve is provided to protect and/or decorate the dock of a horse's tail. The sleeve may allow for attachment of a decorative cover, such as a pre-braided and/or partially braided hairpiece, which substitutes for the need to manually braid a tail, thereby avoiding damage to the natural hairs on the bony structure of the tail known as the dock where all hair follicles reside. The sleeve may allow for braiding of the horse's tail hairs into the decorative cover. Further, in another aspect of the present disclosure, the protective sleeve may be used for preservation of the horse's tail hairs when the horse is not competing as a preventative measure to protect the tail from further damage from rubbing or abrasion.

### BACKGROUND

### Field

Aspects of the present disclosure generally relate to animal husbandry, and, more particularly, to a device for protecting and/or decorating the tail of a horse.

### Background

Horse competitions have been held for many years. Many different types of shows and/or competitions, e.g., dressage, show jumping, hunter derby, eventing, breed-specific competitions, etc., are undertaken at venues worldwide. These competitions display the talents of both horse and rider to show speed, performance of various gaits and steps, ability to overcome obstacles, breed-specific characteristics, etc., and are implemented in regional, national, international, and Olympic competitions.

Because the competitions are judged, and some subjective value may be and/or is required to be included in a competitor's scores, the visual appearances of the horse and rider are important to the participants and may possibly contribute to the competitor's overall score. Grooming a horse entails undertaking daily procedures, and particular emphasis and effort for grooming often commences shortly before any show or competition, and often accelerate towards the end of the show/competition season at year end finals. A good deal of time is spent on the mane and tail of the horse in order to showcase the horse's confirmation and to conform to an overall formal turnout required for successful competition. Because a horse uses its tail to dissuade insects from bothering the horse, the tail often becomes tangled. Further, the length of the tail's hair and the location of the tail often attracts additional dirt, which necessitates additional efforts for show preparation. The condition of a horse's tail varies from horse to horse given genetic factors, feeding regimens, overall care, health status, etc.

For shows and competitions, tails are often braided or otherwise interwoven to provide some visual interest and for tail management. This achieves a more formal look in step with the formalities of the competitive sport across many disciplines. Tail extensions are often woven into the base of the tail to provide a fuller look to the bottom of the tail. The top of the tail, called the dock, is a bony structure of the tail covered in skin where all tail hair follicles originate. The dock is often braided far above where the tail attachment is added. The tight architecture of the braid often leads to thinning and/or breakage of the tail hairs along the entire length of the dock. Often the skin on tails becomes irritated and can even bleed. This practice is less than optimum for horse health and the restoration of the damaged tail can take months of diligent effort with varied results. Further, given certain health conditions or environmental conditions, horses may rub their docks against fence posts, barn sidings, etc., when the horse's hind quarters are irritated, leading to further thinning/removal of tail hairs.

### SUMMARY

In an aspect of the present disclosure, a protective sleeve is provided to protect the dock of a horse's tail during a period of discomfort to prevent attempts at itching and damaging the tail. The sleeve can also allow for attachment of a fake top tail to cover the damaged section of tail on the dock to achieve a natural look while healing takes place. A decorative cover, such as a pre-braided and/or partially braided hairpiece or toupee, which may allow for braiding of the horse's tail hairs into the decorative cover can be used for competition to avoid an unprofessional look of a damaged, hairless upper tail/dock. Further, in another aspect of the present disclosure, the protective sleeve may possibly be used for preservation of the horse's tail hairs when the horse is not competing in the event the horse has a habit of damaging the upper portion of the tail.

A sleeve for a horse tail in accordance with an aspect of the present disclosure may comprise a cylinder having a diameter and a length, and a band, coupled around a circumference of the cylinder, for adjusting at least the diameter of the cylinder such that an adjustment of the band compresses the sleeve against the horse tail at a desired location.

Such a sleeve may further optionally include a cover, coupled to at least one of the cylinder and the band, the cover providing a decoration to the horse tail, a length of the cover being larger than the length of the cylinder, the cover comprising a braided hairpiece and/or a hairpiece that is also coupled to the horse tail a liner, coupled at least to the cylinder, the liner comprising a material capable of retaining at least one of a liniment, a salve, a balm, a liquid, and a cream and/or positioning the least one liniment, salve, balm, liquid, and cream proximate the horse tail.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further purposes and advantages, will be better understood from the following description when considered in connection with the accompanying figures. It is to be expressly understood, however, that each of the figures is provided for the purposes of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings. The accompanying drawings are not necessarily to scale, and are to be construed as illustrating the principles of the disclosure in one or more aspects. In the figures, like reference numerals designate corresponding parts throughout the various figures presented herein.

FIG. 1 illustrates a perspective view of a sleeve in accordance with an aspect of the present disclosure;

FIG. 2 illustrates a sleeve with an adjustment band in accordance with an aspect of the present disclosure;

FIG. 3 illustrates a sleeve with an adjustment band in accordance with an aspect of the present disclosure;

FIGS. 4A-4F illustrate a braid in accordance with an aspect of the present disclosure; and

FIGS. 5A-5E illustrate a braid in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

### Overview

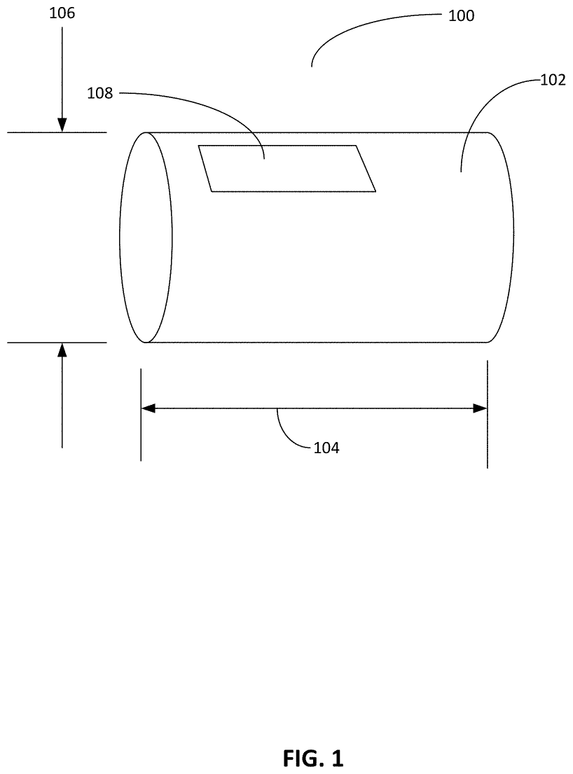

FIG. 1 illustrates a perspective view of a sleeve in accordance with an aspect of the present disclosure.

Sleeve 100 is a generally a cylinder 102 of length 104 and diameter 106. The cylinder 102 may also have attachment point 108 for attaching other items to sleeve 100.

Cylinder 102 may be made from an elastomeric material, e.g., polymeric materials with a highly elastic nature such as natural rubber, synthetic rubber, silicone rubber, ethylene vinyl acetate (EVA) rubber, etc. Further, cylinder 102 may be an elastomeric material combined with cloth fibers, such as cotton, linen, etc., or other natural or synthetic fibers, similar to those materials used in an elastic waistband and/or wristband used in human clothing. Other materials, such as viscoelastic materials which strain linearly with time when stresses are applied, are also envisioned as being within the scope of the present disclosure. Cylinder 102 may also be of a different cross-sectional area, e.g., oval, square, hexagonal, etc., without departing from the scope of the present disclosure. Further, cylinder 102 may not be continuous as shown in FIG. 1, e.g., cylinder 102 may have a slit that runs along the length 104 of cylinder 102, has a spiral-shaped slit running along the length of cylinder 102, etc., without departing from the scope of the present disclosure.

Sleeve 100 may also allow for the application of liniment, salve, or other restorative balms, liquids, creams, etc., to be applied to a horse's tail hairs. As such, sleeve 100 may also include fabric, gauze, etc. that can retain and release such liquids, creams, etc. for restorative purposes, cleaning purposes, shine/silkiness additives, and/or other visual and/or medicinal reasons. For example, and not by way of limitation, a sleeve 100 with a liner may be used on a horse that has a damaged and/or thinning tail, where the liner is used to apply liniment, salve, etc. to the tail for elongated periods of time. The liner may be removed and replaced as necessary, while sleeve 100 holds the liner at a specific location on the horse's tail where repair is desired.

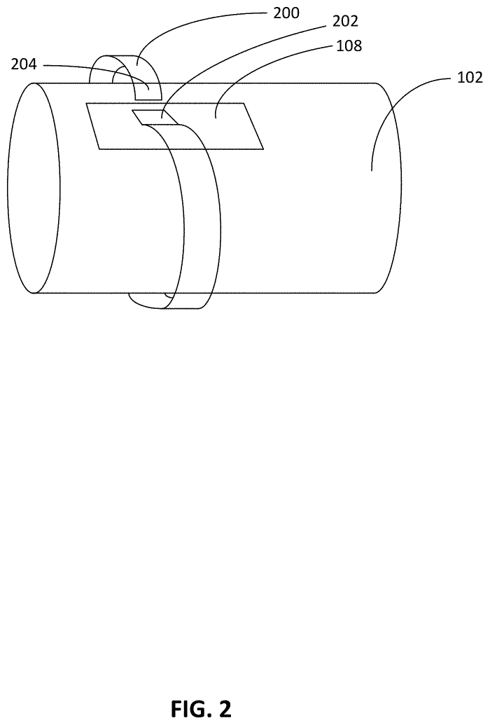

In an aspect of the present disclosure, length 104 and diameter 106 may be the unexpanded dimensions of cylinder 102. Length 104 may be of any length as desired, but may fall within the range of 1″ to 10″ for ease of use. Diameter 106 may be smaller than the diameter of the dock of a horse's tail, such that cylinder 102 may be applying compression when applied to a horse's dock. For ease of installation, diameter 106 may be larger than the diameter of the dock of a horse's tail, and elastic bands may be applied around and/or inside cylinder as shown in FIG. 2. In such an aspect, the tail may be drawn through the sleeve 100 and placed on the tail as desired, and then the sleeve 100 may be attached and/or contracted as desired to maintain the positioning of sleeve 100 on a particular location of the tail.

Depending on whether sleeve 100 is being used for medicinal/visual purposes, sleeve 100 may be longer to allow for additional surface area of sleeve 100 to contact the horse's tail, which may promote faster healing, faster hair repair, faster hair growth, and/or other benefits.

Attachment point 108 may be used to attach strands of hair, braids, braiding aids, and/or other decorative materials to sleeve 100, and/or may be used as an attachment point for elastic bands to compress the tail hairs, and/or for attaching other items to sleeve 100. Although shown substantially as rectangular, attachment point 108 may be of any shape, and may be of any type of attachment means, without departing from the scope of the present disclosure. Attachments may cover the entire length of sleeve 100, and/or may be shorter or longer than sleeve 100 as desired.

FIG. 2 illustrates a sleeve with an adjustment band in accordance with an aspect of the present disclosure.

Adjustment band 200 is shown attached to attachment point 108 of cylinder 102. Adjustment band 200 is attached to attachment point 108 at tab 202. Tab 202 may be a hook-and-loop attachment, a snap attachment, a button and/or button stud attachment, and/or any other form of attachment means without departing from the scope of the present disclosure. Adjustment band 200 may be an elastic material, string, drawstring, or may be a semi-elastic and/or non-elastic material as desired. The opposing end of adjustment band 200 may be fitted with another tab 204 for attaching to attachment point 108, or to other attachment points on cylinder 102 as desired. In an aspect of the present disclosure, adjustment band 200 may be coupled to cylinder 102 along the length of cylinder 102 to cinch cylinder 102 together, similar to a shoelace, and may have a cord lock, spring-compression type closure, etc. to more readily change the length of adjustment band 200. Many types of adjustment bands 200, methods and/or apparatuses for reducing the length of the adjustment band 200, and/or attachments of adjustment band 200 to cylinder 102 are possible without departing from the scope of the present disclosure.

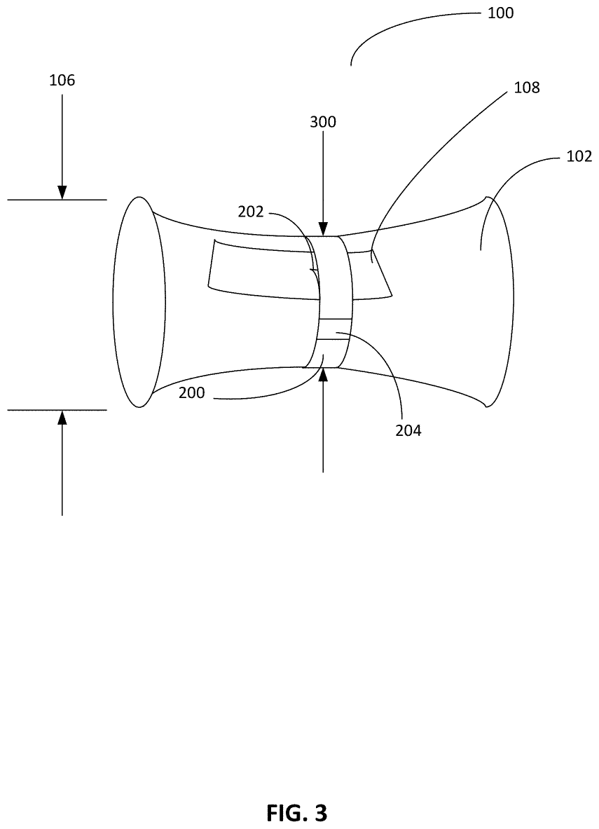

FIG. 3 illustrates a sleeve with an adjustment band in accordance with an aspect of the present disclosure.

By adjusting the length of adjustment band 200, e.g., shortening and/or lengthening the adjustment band 200, diameter 300 of cylinder 102 may be reduced when compared to diameter 106. Because diameter 106 may not fit all horses, the ability to reduce diameter 106, e.g., by attaching tab 204 to adjustment band 200 and/or attachment point 208, the ability to apply a desired amount of pressure to the horse's tail is possible within the scope of the present disclosure. In such an aspect of the present disclosure, sleeve 100 may be easily and quickly removed from the horse's tail for cleaning and/or modification as desired. The desired pressure of sleeve 100, as determined by the material used to make sleeve 100 and/or the adjustable length of adjustment band 200, may provide additional stimulation to the dock and/or tail. Such stimulation may be helpful in promoting hair growth, hair follicle thickening, and/or provide other benefits.

Although shown as a single adjustment band, in an aspect of the present disclosure a plurality of adjustment bands 200 may be used without departing from the scope of the present disclosure. Further, multiple attachment points 108 may be placed on sleeve 100 without departing from the scope of the present disclosure.

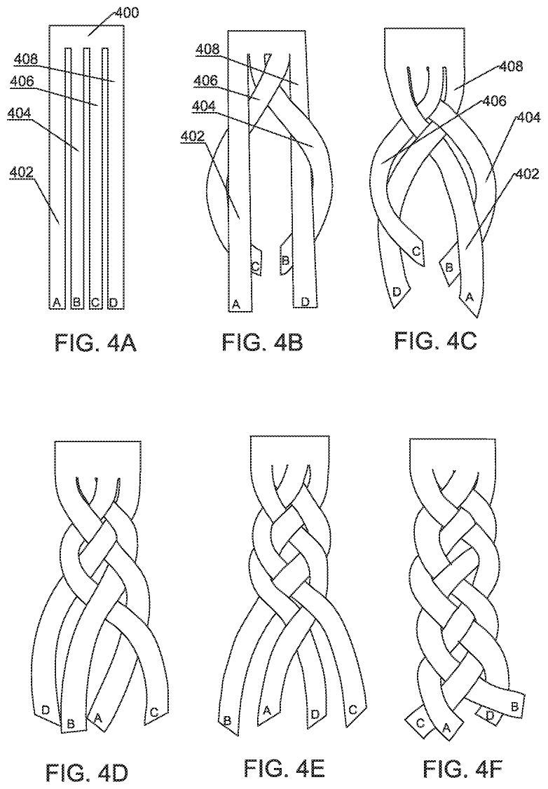

FIGS. 4A-4F illustrate a braid in accordance with an aspect of the present disclosure.

In an aspect of the present disclosure, strands of unbraided hair can be attached to sleeve 100, at attachment point 108 and/or other locations on sleeve 100. In another aspect of the present disclosure, a pre-braided hairpiece can be attached to sleeve 100, in conjunction with and/or instead of strands of unbraided hair. Although many are familiar with a three-strand style of French braid, other types of braiding are possible, many of which use more than three strands. As shown in FIG. 4A, a group 400 may be divided into four strands 402-408. Group 400 may be the tail hairs of a horse, however, one or more strands 402-408 may be added hair, synthetic hair, dyed hair, etc., to increase the visual interest, to thicken a tail that is thinning, or for other reasons as desired. FIG. 4B illustrates that strand 406 is placed over strand 404 and then under and around strand 402, while strand 404 is brought under strand 406 and over and around strand 408. FIG. 4C illustrates strand 408 being brought over and across strand 402, and under strand 406, while strand 402 is brought under strand 408 and over strand 404. This “over-under from the left” and “under-over from the right” pattern is continued in FIGS. 4D-4F, which results in a four-strand braid.

A braid such as shown in FIGS. 4A-4F may be pre-made with similar and/or dyed hair and attached to sleeve 100, or may be partially made or may have one or more strands 402-408 filled with a string, etc., to be tied to the horse's actual tail hairs and pulled through the braid with minimal effort. In such an aspect of the present disclosure, such approaches may relieve stress and/or reduce breakage of the horse's tail hairs while still providing visual interest during shows and/or competitions. Such approaches, e.g., string pulling, pre-made braids, etc., may also be easily removed and sleeve 100 reattached to the horse's tail to provide comfort and/or repair to the horse's tail after competitions and/or shows. In an aspect of the present disclosure, sleeve 100 may be used for competitions, which may minimize damage or reduce further damage to the tail, which may allow for regrowth of the tail hairs without additional irritation from manual braiding. In additional to natural tail hair and braided tail presentations, additional items, e.g., pom poms, glitter, etc. may be added to sleeve 100 for younger competitors to enhance visual interest.

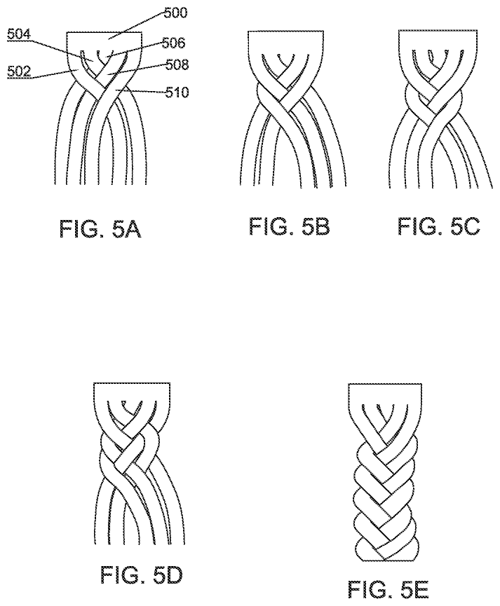

FIGS. 5A-5E illustrate a braid in accordance with an aspect of the present disclosure.

Braids are not limited to four different strands; flat and spiral braids have been made from 5, 6, 8, 9, 10, 11, 15, 16, 20, 24, 28, and other numbers of strands. FIGS. 5A-5E illustrate a five strand “herringbone” style braid, using group 500 with five strands 502-510. Center strand 506 moves from the center of group 500 to the far right, back to the center, and then across to the right. This type of braid may allow for a horse with thinning hair to have the natural hair to be woven into the braid naturally from the center (as center strand 506), which may help conceal any synthetic hairs that may be used in group 500.

In an aspect of the disclosure, the braid shown in FIGS. 4 and 5 may be made from natural horse hairs, and attached to sleeve 100 to completely cover a horse's tail. For example, and not by way of limitation, sleeve 100 may comprise a braided design that is attached to sleeve 100 in some fashion, e.g., via hook-and-loop fasteners, on attachment point 108, etc., to cover a thinner or thinning tail and/or dock. Sleeve 100 may be a stand-alone attachment if desired.

Again, braids such as shown in FIGS. 5A-5E may be pre-made with similar and/or dyed hair and attached to sleeve 100, to be attached to the horse's actual tail hairs by sleeve 100 with minimal effort. In such an aspect of the present disclosure, such approaches may relieve stress and/or reduce breakage of the horse's tail hairs while still providing visual interest during shows and/or competitions.

Attachment point 108 may also be used to attach other items to sleeve 100, e.g., rings, loops, and/or additional adornments for visual and/or restorative purposes. For example, and not by way of limitation, the braids shown in FIGS. 4A-4F and 5A-5E may be concluded with a ring or specialized knot to allow for additional integration of the horse's natural hair with any synthetic hair that is used in such braids. Other items, e.g., elastic bands, coordinating materials to match a rider's clothing/costume, etc., may also be attached to sleeve 100 without departing from the scope of the present disclosure.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a view of the device as shown in the present disclosure. Of course, if the device is inverted, above becomes below, and vice versa. Additionally, if oriented sideways, above and below may refer to sides of a device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, and algorithm steps described in connection with the disclosure herein may be implemented as various different types of materials and/or various different combinations of materials. To clearly illustrate this interchangeability, various illustrative components, blocks, modules, and steps have been described above generally in terms of their functionality. The various materials and/or combinations of materials employed to implement the present disclosure depends upon the particular application and design constraints imposed on the overall system. Skilled artisans may implement the described functionality in varying ways for each particular application, but such implementation decisions should not be interpreted as causing a departure from the scope of the present disclosure.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. A sleeve for a horse tail, comprising:
a cylinder having a diameter and a length; and
a band, coupled around a circumference of the cylinder, for adjusting at least the diameter of the cylinder such that an adjustment of the band compresses the sleeve against the horse tail at a desired location.

2. The sleeve of claim 1, further comprising a cover, coupled to at least one of the cylinder and the band, in which the cover provides a decoration to the horse tail.

3. The sleeve of claim 2, in which a length of the cover is larger than the length of the cylinder.

4. The sleeve of claim 3, in which the cover comprises a braided hairpiece.

5. The sleeve of claim 3, in which the cover comprises a hairpiece that is also coupled to the horse tail.

6. The sleeve of claim 1, further comprising a liner, coupled at least to the cylinder.

7. The sleeve of claim 6, in which the liner comprises a material capable of retaining at least one of a liniment, a salve, a balm, a liquid, and a cream.

8. The sleeve of claim 7, in which the liner positions the least one liniment, salve, balm, liquid, and cream proximate the horse tail.
